(19) United States
(12) Patent Application Publication
(10) Pub. No.: US 2023/0132739 A1
(43) Pub. Date: May 4, 2023

(54) Machine Learning Model Calibration with Uncertainty

(71) Applicant: S&P Global Inc., New York, NY (US)

(72) Inventor: Zachary Anglin, Storrs Mansfield, CT (US)

(21) Appl. No.: 17/453,401

(22) Filed: Nov. 3, 2021

(51) Int. Cl. G06N 20/00; G06F 17/18; G06Q 10/06

(52) U.S. Cl. CPC G06N 20/00; G06F 17/18; G06Q 10/067

(57) ABSTRACT

A method, apparatus, system, and computer program code for calibrating a machine learning classification model with uncertainty interval. A machine learning classification model, trained on a training data set, is provided in a computer that models a probabilistic relationship between observed values and discrete outcomes. The computer generates a validation of the machine learning classification model from a validation data set. The validation includes a model confidence at the observed value. For each validation, the computer receives a correctness indication of a discrete outcome. Using a calibration service, the computer generates an uncertainty interval over the validation. The uncertainty interval is generated from the model confidence and the correctness indication. The computer calibrates the model confidence to probabilities of the discrete outcomes based on the uncertainty interval.

### BACKGROUND

### 1. Field

The disclosure relates generally to an improved computer system and, more specifically, to a method, apparatus, computer system, and computer program product for calibrating a machine learning classification model with uncertainty interval.

### 2. Description of the Related Art

Machine learning involves using machine learning algorithms to build machine learning models based on samples of data. The samples of data used for training referred to as training data or training data sets. Machine learning models trained using training data sets and make predictions without being explicitly programmed to make these predictions. Machine learning models can be trained for a number of different types of applications. These applications include, for example, medicine, healthcare, speech recognition, computer vision, or other types of applications.

These machine learning algorithms can include supervised machine learning algorithms and unsupervised machine learning algorithms. Supervised machine learning can train machine learning models using data containing both the inputs and desired outputs.

### SUMMARY

According to one embodiment of the present invention, a method in a computer provides for calibrating a machine learning classification model with uncertainty interval. A machine learning classification model, trained on a training data set, is provided in a computer that models a probabilistic relationship between observed values and discrete outcomes. The computer generates a validation of the machine learning classification model from a validation data set. The validation includes a model confidence at the observed value. For each validation, the computer receives a correctness indication of a discrete outcome. Using a calibration service, the computer generates an uncertainty interval over the validation. The uncertainty interval is generated from the model confidence and the correctness indication. The computer calibrates the model confidence to probabilities of the discrete outcomes based on the uncertainty interval.

According to another embodiment of the present invention, a computer system comprises a hardware processor. The computer system further comprises a machine learning classification model and a calibration service, both in communication with the hardware processor. The machine learning classification model is trained on a training data set. The machine learning classification model models a probabilistic relationship between observed values and discrete outcomes. A validation of the machine learning classification model is generated from a validation data set. The validation includes a model confidence at the observed value. For each validation, a correctness indication is received for a discrete outcome predicted by the machine learning classification model. The calibration service generates an uncertainty interval over the validation. The uncertainty interval is generated from the model confidence and the correctness indication. The calibration service calibrates the model confidence to probabilities of the discrete outcomes based on the uncertainty interval.

According to yet another embodiment of the present invention, a computer program product comprises a computer-readable storage media with program code stored on the computer-readable storage media for calibrating a machine learning classification model with uncertainty interval. The program code is executable by a computer system: to provide a machine learning classification model, trained on a training data set, that models a probabilistic relationship between observed values and discrete outcomes; to generate, from a validation data set, a validation of the machine learning classification model, wherein the validation includes a model confidence at the observed value; to receive, for each validation, a correctness indication of a discrete outcome; to generate, by a calibration service, an uncertainty interval over the validation, wherein the uncertainty interval is generated from the model confidence and the correctness indication; and to calibrate the model confidence to probabilities of the discrete outcomes based on the uncertainty interval.

### BRIEF DESCRIPTION OF THE DRAWINGS

FIG. 1 is a pictorial representation of a network of data processing systems in which illustrative embodiments may be implemented;

FIG. 2 is a block diagram of a machine learning environment is depicted in accordance with an illustrative embodiment;

FIG. 3 is a data flow diagram for a record linkage use case is depicted according to an illustrative embodiment;

FIG. 4 is a plot of data points depicted in accordance with an illustrative embodiment;

FIG. 5 is an illustration of a calibration curve depicted in accordance with an illustrative embodiment;

FIG. 6 is an illustration of a second calibration curve depicted in accordance with an illustrative embodiment;

FIG. 7 is a flowchart of a process for calibrating a machine learning classification model with uncertainty interval depicted in accordance with an illustrative embodiment

FIG. 8 is a flowchart of a process generating the uncertainty interval depicted in accordance with an illustrative embodiment

FIG. 9 is a flowchart of a process for shrinking an uncertainty interval around a calibration depicted in accordance with an illustrative embodiment;

FIG. 10 is a flowchart of a process for applying model predictions according to a selected confidence threshold depicted in accordance with an illustrative embodiment;

FIG. 11 is a flowchart of a process for calibrating a generic model depicted in accordance with an illustrative embodiment; and

FIG. 12 is a block diagram of a data processing system in accordance with an illustrative embodiment.

### DETAILED DESCRIPTION

The illustrative embodiments recognize and take into account one or more different considerations. For example, the illustrative embodiments recognize and take into account that machine learning models that perform classification tend to issue binary outputs. These binary outputs can be issued across many classes. The machine learning model chooses one of those classes according to the model confidence. For example, a classification model for performing image analysis may include two or more possible classifications, such as a dog, a cat, an alligator, a hippopotamus, and an elephant.

The illustrative embodiments recognize and take into account that Classification models generate a normalized distribution of a discrete outcome across the available classes. Humans tend incorrectly to ascribe probabilistic properties to these class assignments, conflating model confidence with the actual probabilistic outcomes. However, this distribution does not necessarily represent a “true” probability that the class assignments are correct. Instead, the distribution is the output of various rewards and penalties given to the model's optimization functions.

The illustrative embodiments recognize and take into account that current model calibration methodologies simply append additional layers on top of the classification model. These calibrations consume model confidence from the classification model and based on some external evaluation, determine an actual observed probability.

The illustrative embodiments recognize and take into account that these calibrations are curves that map model confidence to observed probability. However, calibration is only an estimate. In other words, calibration cannot determine the exact probability for the occurrence of a random outcome variable, even for point estimates.

Thus, the illustrative embodiments recognize and take into account that it would be desirable to have a method, apparatus, computer system, and computer program product that take into account the issues discussed above as well as other possible issues. For example, it would be desirable to have a method, apparatus, computer system, and computer program product that Calibration service 206 provides model calibration in a Bayesian framework with support for uncertainty.

In one illustrative example, a computer system is provided for calibrating a machine learning classification model with uncertainty interval. The computer system provides a machine learning classification model, trained on a training data set, that models a probabilistic relationship between observed values and discrete outcomes. The computer system generates, from a validation data set, a validation of the machine learning classification model. The validation includes a model confidence at the observed value. For each validation, the computer system receives a correctness indication of a discrete outcome. The computer system generates an uncertainty interval over the validation. The uncertainty interval is generated from the model confidence and the correctness indication. The computer system calibrates the model confidence to probabilities of the discrete outcomes based on the uncertainty interval.

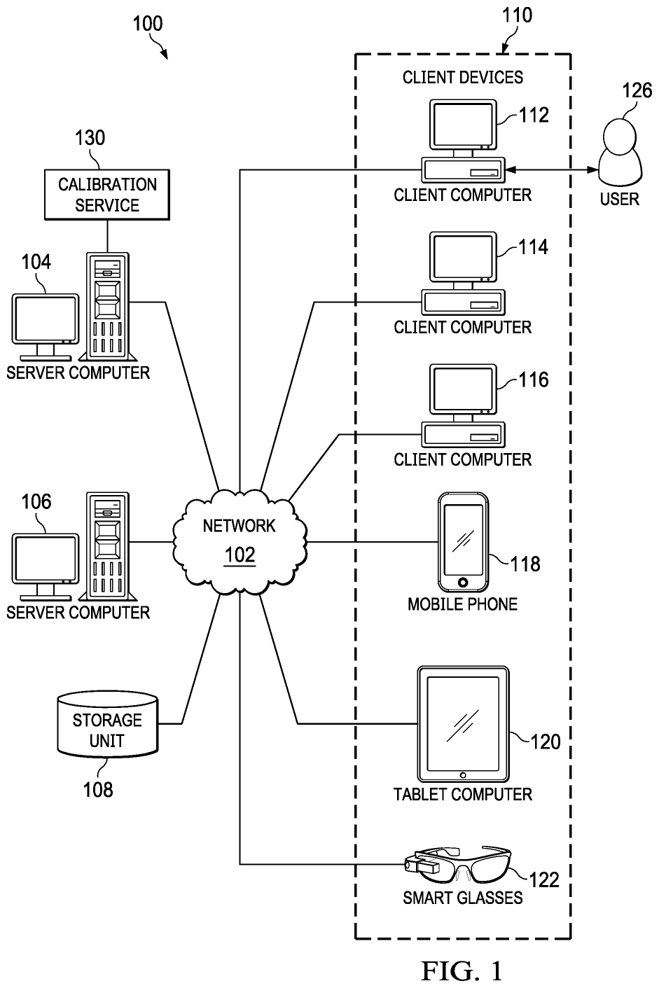

With reference now to the figures and, in particular, with reference to FIG. 1, a pictorial representation of a network of data processing systems is depicted in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server computer 104 and server computer 106 connect to network 102 along with storage unit 108. In addition, client devices 110 connect to network 102. As depicted, client devices 110 include client computer 112, client computer 114, and client computer 116. Client devices 110 can be, for example, computers, workstations, or network computers. In the depicted example, server computer 104 provides information, such as boot files, operating system images, and applications to client devices 110. Further, client devices 110 can also include other types of client devices such as mobile phone 118, tablet computer 120, and smart glasses 122. In this illustrative example, server computer 104, server computer 106, storage unit 108, and client devices 110 are network devices that connect to network 102 in which network 102 is the communications media for these network devices. Some or all of client devices 110 may form an Internet of things (IoT) in which these physical devices can connect to network 102 and exchange information with each other over network 102.

Client devices 110 are clients to server computer 104 in this example. Network data processing system 100 may include additional server computers, client computers, and other devices not shown. Client devices 110 connect to network 102 utilizing at least one of wired, optical fiber, or wireless connections.

Program code located in network data processing system 100 can be stored on a computer-recordable storage media and downloaded to a data processing system or other device for use. For example, the program code can be stored on a computer-recordable storage media on server computer 104 and downloaded to client devices 110 over network 102 for use on client devices 110.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, governmental, educational, and other computer systems that route data and messages. Of course, network data processing system 100 also may be implemented using a number of different types of networks. For example, network 102 can be comprised of at least one of the Internet, an intranet, a local area network (LAN), a metropolitan area network (MAN), or a wide area network (WAN). FIG. 1 is intended as an example, and not as an architectural limitation for the different illustrative embodiments.

As used herein, a “number of,” when used with reference to items, means one or more items. For example, a “number of different types of networks” is one or more different types of networks.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combinations of these items can be present. In some illustrative examples, “at least one of” can be, for example, without limitation, two of item A; one of item B; and ten of item C; four of item B and seven of item C; or other suitable combinations.

In the illustrative example, user 126 operates client computer 112. User can 126 operate client computer 112 to access calibration service 130. In the illustrative example, calibration service 130 can provides model calibration in a Bayesian framework with support for uncertainty of expected values for an unknown parameter.

In this illustrative example, calibration service 130 can run on server computer 104. In another illustrative example, calibration service 130 can be run in a remote location such as on client computer 114 and can take the form of a system instance of the application. In yet other illustrative examples, calibration service 130 can be distributed in multiple locations within network data processing system 100. For example, calibration service 130 can run on client computer 112 and on client computer 114 or on client computer 112 and server computer 104 depending on the particular implementation.

Calibration service 130 can operate to provide a framework for calibrating classification model with uncertainty. Calibration service 130 adopts a Bayesian statistical framework that assumes inherent randomness and determines ranges of unobserved random variables.

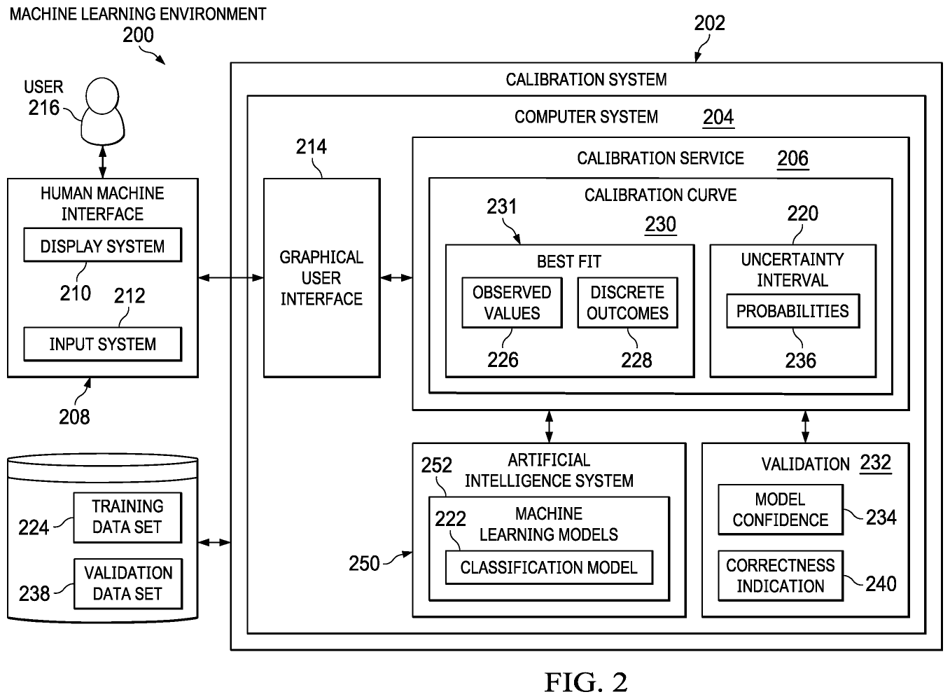

With reference now to FIG. 2, a block diagram of a machine learning environment is depicted in accordance with an illustrative embodiment. In this illustrative example, machine learning environment 200 includes components that can be implemented in hardware such as the hardware shown in network data processing system 100 in FIG. 1.

As depicted, calibration system 202 comprises computer system 204 and calibration service 206. Calibration service 206 runs in computer system 204. calibration service 206 can be implemented in software, hardware, firmware, or a combination thereof. When software is used, the operations performed by calibration service 206 can be implemented in program code configured to run on hardware, such as a processor unit. When firmware is used, the operations performed by calibration service 206 can be implemented in program code and data and stored in persistent memory to run on a processor unit. When hardware is employed, the hardware may include circuits that operate to perform the operations in calibration service 206.

In the illustrative examples, the hardware may take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

Computer system 204 is a physical hardware system and includes one or more data processing systems. When more than one data processing system is present in computer system 204, those data processing systems are in communication with each other using a communications medium. The communications medium can be a network. The data processing systems can be selected from at least one of a computer, a server computer, a tablet computer, or some other suitable data processing system.

As depicted, human machine interface 208 comprises display system 210 and input system 212. Display system 210 is a physical hardware system and includes one or more display devices on which graphical user interface 214 can be displayed. The display devices can include at least one of a light emitting diode (LED) display, a liquid crystal display (LCD), an organic light emitting diode (OLED) display, a computer monitor, a projector, a flat panel display, a heads-up display (HUD), or some other suitable device that can output information for the visual presentation of information.

User 216 is a person that can interact with graphical user interface 214 through user input generated by input system 212 for computer system 204. Input system 212 is a physical hardware system and can be selected from at least one of a mouse, a keyboard, a trackball, a touchscreen, a stylus, a motion sensing input device, a gesture detection device, a cyber glove, or some other suitable type of input device.

In this illustrative example, human machine interface 208 can enable user 216 to interact with one or more computers or other types of computing devices in computer system 204. For example, these computing devices can be client devices such as client devices 110 in FIG. 1.

In this illustrative example, calibration service 206 in computer system 204 is configured to calibrate a machine learning classification model with uncertainty interval 220. In these illustrative examples, calibration service 206 can use artificial intelligence system 250. Artificial intelligence system 250 is a system that has intelligent behavior and can be based on the function of a human brain. An artificial intelligence system comprises at least one of an artificial neural network, a cognitive system, a Bayesian network, a fuzzy logic, an expert system, a natural language system, or some other suitable system. Machine learning is used to train the artificial intelligence system. Machine learning involves inputting data to the process and allowing the process to adjust and improve the function of the artificial intelligence system.

In this illustrative example, artificial intelligence system 250 can include a set of machine learning models 252. A machine learning model is a type of artificial intelligence model that can learn without being explicitly programmed. A machine learning model can learn based on training data input into the machine learning model. The machine learning model can learn using various types of machine learning algorithms. The machine learning algorithms include at least one of a supervised learning, an unsupervised learning, a feature learning, a sparse dictionary learning, and anomaly detection, association rules, or other types of learning algorithms. Examples of machine learning models include an artificial neural network, a decision tree, a support vector machine, a Bayesian network, a genetic algorithm, and other types of models. These machine learning models can be trained using data and process additional data to provide a desired output.

Classification algorithms are used to divide a dataset into classes based on different parameters. The task of the classification algorithm is to find a mapping function to map an input (x) to a discrete output (y). In other words, classification algorithms are used to predict the discrete values for the classifications, such as Male or Female, True or False, Spam or Not Spam, etc. Types of Classification Algorithms include Logistic Regression, K-Nearest Neighbors, Support Vector Machines (SVM), Kernel SVM, Naive Bayes, Decision Tree Classification, and Random Forest Classification.

In this illustrative example, calibration service 206 provides a classification model 222, trained on a training data set 224. Classification model 222 models a probabilistic relationship between observed values 226 and discrete outcomes 228 based validation data set 238.

Calibration service 206 provides model calibration in a Bayesian framework with support for uncertainty. Calibration service 206 replaces other commonly used calibration approaches that merely append a Bayesian network or Bayesian models on top of existing classification models. Rather than continuously refining a best fit calibration to match the training data set 224, calibration service 206 assumes that individual data points are random, and then fits and adapts uncertainty interval 220 around the mutable calibration curve 230 as more validations 232 are received.

In other words, calibration service 206 ingests model confidence 234 generated by machine learning models 252 and maps those confidences to the probabilities 236 of a correct positive classification. Based on those probabilities 236, calibration service 206 builds an uncertainty interval 220, and mutates the calibration curve 230 according to uncertainty interval 220. As more validations 232 are received, thereby building greater epistemic confidence, uncertainty interval 220 shrinks.

In this illustrative example, calibration service 206 generates one or more validations 232 of the classification model 222 from a validation data set 238. Validations 232 includes a model confidence 234 at the observed value, as well as a correctness indication 240 submitted from a user 216. Calibration service 206 operates over validations 232, generated from validation data set 238.

For each validation of validations 232, calibration service 206 receives a correctness indication 240 of a discrete outcome. Correctness indication 240 can be provided from the user 216 as part of a supervised learning process.

Calibration service 206 generates an uncertainty interval 220 over the validation. uncertainty interval 220 is an estimate computed from validation data set 238. Uncertainty interval 220 provides a range of expected values for an unknown parameter, for example, a population mean. Uncertainty interval 220 is generated from the model confidence and the correctness indication.

Calibration service 206 calibrates model confidence 234 to probabilities 236 of the discrete outcomes 228 based on the uncertainty interval 220. In this illustrative example, calibration curve 230 is a logistic curve of best fit 231. Calibration service 206 generating the logistic curve bounded over the uncertainty interval 220. Calibration service 206 then displays the logistic curve with the uncertainty interval 220 on a graphical user interface 214.

Calibration service 206 may generate a calibration curve 230 based on a logistic function that models expected probabilities 236 as a function of observed values 226. The logistic function can take the form of:

$$p ( t ) = \frac{1}{1 + {e}^{β t + α}} \qquad Eq . 1$$

### Wherein:

α determines the position (bias) of the calibration curve; and

β determines the steepness (slope) of the calibration curve.

Initially, Calibration service 206 may generate calibration curve 230 by imposing prior probabilities, or simply “priors”, for the expected values of α and β. Both α and β can be relatively weak priors, enabling calibration service 206 to dramatically vary the shape of calibration curve 230 as additional validations 232 are received.

Both α and β are unbounded variables and can be either positive or negative. Both α and β encodes high uncertainty, implying a low value for the encoded certainty (τ) of calibration curve 230 that assumes a large standard deviation in the normal distribution:

$$τ = \frac{1}{{σ}^{2}} \qquad Eq . 2$$

### Wherein:

τ is the encoded certainty; and

σ² is the standard deviation.

For example, Calibration service 206 may randomly sample model predictions from validation data set 238. User 216 can then validate those predictions, by submitting a correctness indication 240 that indicates whether the model predictions are correct or incorrect. Together with model confidence 234, the correctness indication 240 forms validations 232. As additional Validations 232 are generated, calibration service 206 builds uncertainty interval 220, and mutates the calibration curve 230 to fit uncertainty interval 220.

In one illustrative example, the classification model 222 is a generic model that can be applied to varied purposes of a number of business applications. For each of the business applications, an application specific training data set can be used to train the generic model. Using the generic model, calibration service 206 can perform generating validations 232 and uncertainty interval 220, as well as independently calibrating the model confidence for each business application.

At a high level, calibration service 206 changes the focus of the supervised learning process. Other calibration methodologies essentially determine whether there is enough data to generate an accurate calibration curve. In contrast, calibration service 206 determines whether the current amount of uncertainty acceptable for a particular application. With each additional validations 232, the uncertainty decreases, shrinking uncertainty interval 220 around calibration curve 230.

For example, in one illustrative example, user 216 may specify an error tolerance for discrete outcomes 228 predicted by classification model 222. In response to receiving the error tolerance, calibration service 206 receives this error tolerance, determining if the uncertainty interval 220 is within the error tolerance. If the uncertainty interval 220 is not within the error tolerance, calibration service 206 may request additional validations, iteratively performing, for a set of, the steps of: generating the validation, receiving the correctness indication, and generating the uncertainty interval until uncertainty interval 220 around calibration curve 230 shrinks to acceptable error tolerance levels.

Therefore, Calibration service 206 overcome shortcomings of other calibration methodologies where data gaps can lead to poor calibration. Calibration service 206 is able to generate a calibration curve 230 based on a single validation, albeit with a wide uncertainty interval 220.

Computer system 204 can be configured to perform at least one of the steps, operations, or actions described in the different illustrative examples using software, hardware, firmware, or a combination thereof. As a result, computer system 204 operates as a special purpose computer system in calibration service 206 in computer system 204. In particular, calibration service 206 transforms computer system 204 into a special purpose computer system as compared to currently available general computer systems that do not have calibration service 206. In this example, computer system 204 operates as a tool that can increase at least one of speed, accuracy, or usability of computer system 204.

The illustration of machine learning environment 200 in FIG. 2 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

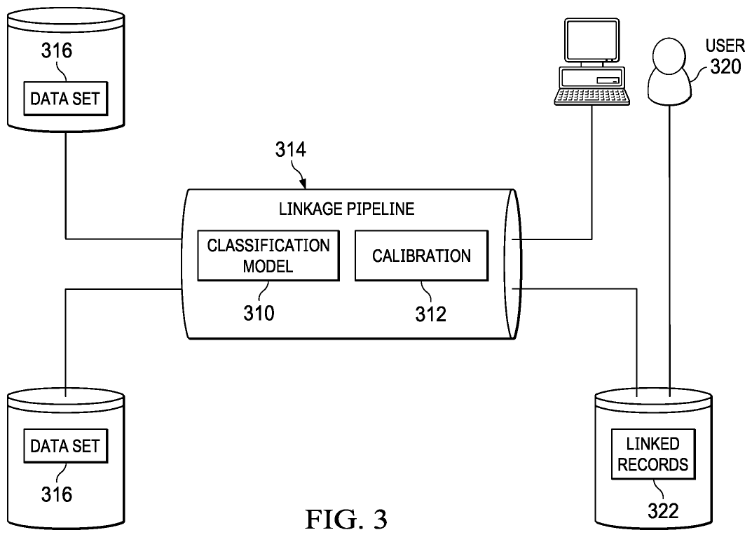

Referring now to FIG. 3, a data flow diagram for a record linkage use case is depicted according to an illustrative embodiment.

Record linkage (also known as data matching, entity resolution, and many other terms) is the task of finding records in a data set that refer to the same entity across different data sources (e.g., data files, books, websites, and databases). Record linkage is necessary when joining different data sets based on entities that may or may not share a common identifier (e.g., database key, URI, National identification number), which may be due to differences in record shape, storage location, or curator style or preference.

As depicted, classification model 310 is deployed with calibration 312 into linkage pipeline 314. Classification model 310 is an example of classification model 222 of FIG. 2. For record pairs between data set 316 and data set 318, or, for example, a Cartesian product between the two datasets, classification model 310 consumes those records pairs and determines whether the records pairs represent the same underlying entity.

Calibration 312 calibrates classification model 310 according to an uncertainty interval determined from validations of predicted matches between record pairs. These validations can be supplied by user 320 in a supervised learning process.

Based on calibration 312, a model confidence can be selected. The model confidence in the coming for example, model confidence 234 of FIG. 2. The model confidence can correspond, for example, to a lower bound of an uncertainty interval, such as uncertainty interval 220 of FIG. 2. This model confidence value is used as a threshold for determining whether manual review by user 320 is required.

As records pairs are ingested into linkage pipeline 314, classification model 310 generates a prediction of the discrete outcome for a data item, i.e., a predicted match or mismatch between the record pairs. Calibration 312 is then used to determine if a probability of that prediction is less than the threshold value.

In response to determining that the probability of the prediction is not less than the confidence threshold, the prediction is automatically applied to the record linkage, or to another corresponding business application for other use cases. In other words, model predictions having a model confidence greater than the threshold, that is, predicted classifications where the model has very low probability of being incorrect, are recorded in linked records 322 based solely on the model prediction, without intervention by user 320.

However, in response to determining that the probability of the prediction is less than the confidence threshold, the prediction flagged for review. In other words, model predictions having a model confidence less than the threshold, that is, predicted classifications where there is a high probability that the model is incorrect, are instead flagged, and forwarded to the user 216 for manual determination of a match or mismatch between the record pairs. In one illustrative example, these manual determinations by user 216 can be used to provide additional validations 232 to calibration service 206 of FIG. 2.

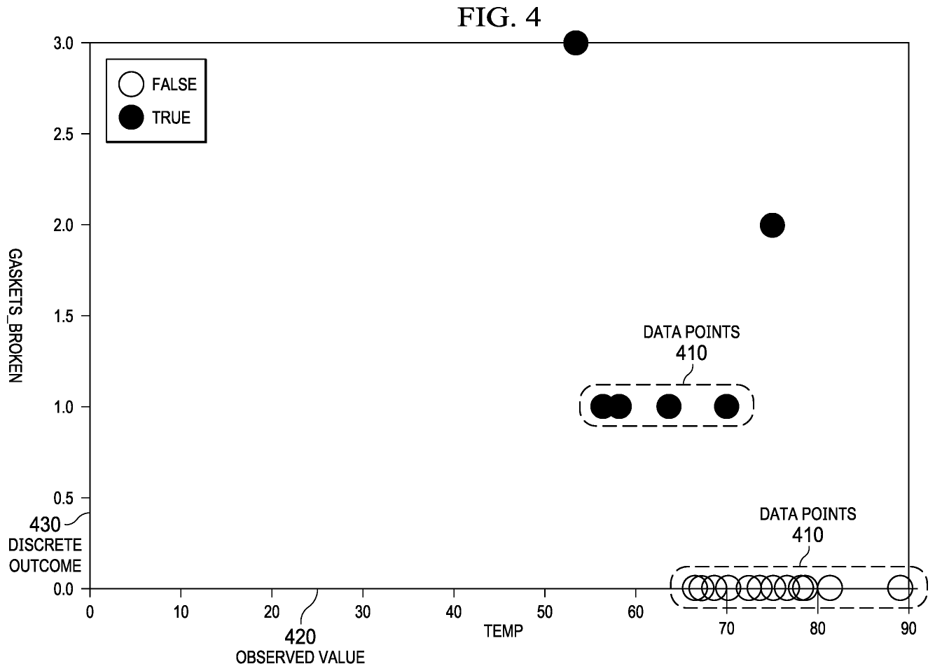

With reference next to FIG. 4, a plot of data points is depicted in accordance with an illustrative embodiment. Data points 410 can be used as part of a validation data set, such as validation data set 238 of FIG. 2.

As illustrated, each of data points 410 have an observed value 420 that correlates to a discrete outcome 430. As depicted, each of data points 410 have an observed value 420 of temperature, that correlates to a discrete outcome 430 of a broken mechanical part, such as a gasket.

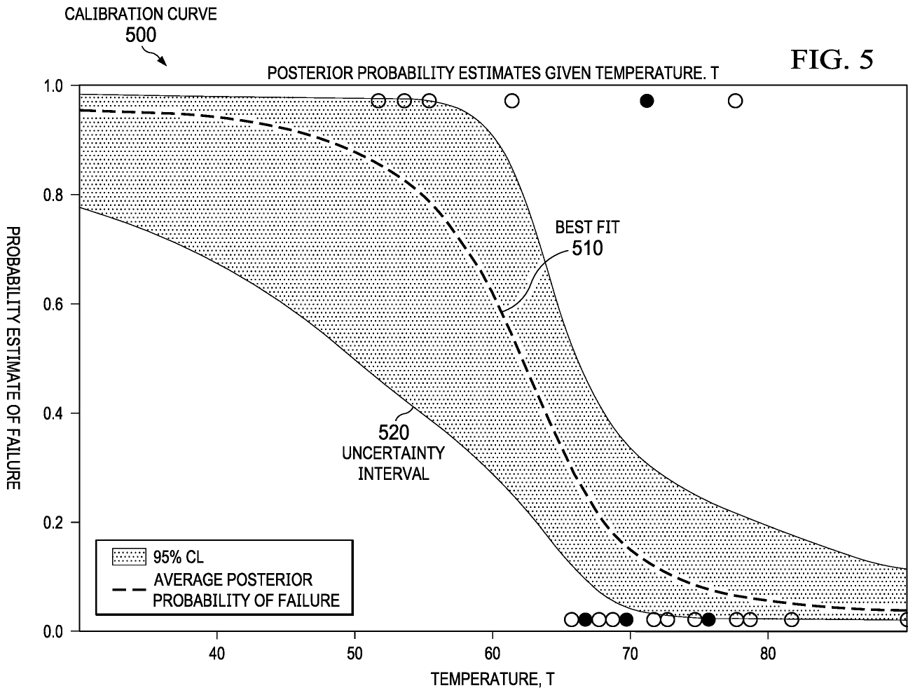

With reference next to FIG. 5, an illustration of a calibration curve is depicted in accordance with an illustrative embodiment. Calibration curve 500 is an example of calibration curve 230, generated by calibration service 206 and displayed on graphical user interface 214 as shown in FIG. 2. Calibration curve 500 is generated from data points 410 of FIG. 4.

In this illustrative example, calibration curve 500 maps model confidence, such as model confidence 234 of FIG. 2, to a probability estimate of correctness, such as probabilities 236 of FIG. 2. As depicted, calibration curve 500 is a logistic curve, including best fit 510, bounded over the uncertainty interval 520.

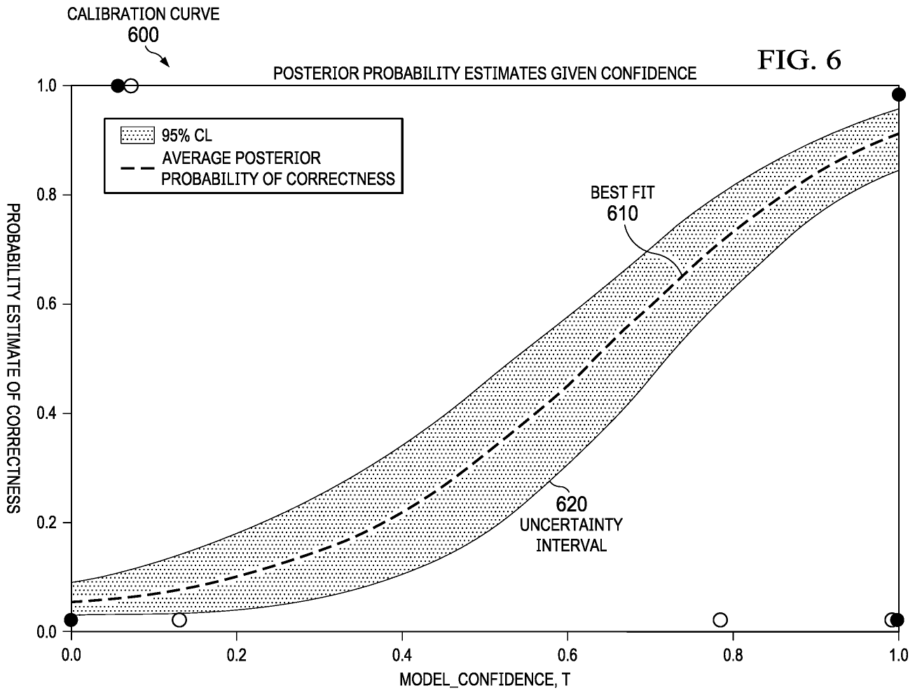

With reference next to FIG. 6, an illustration of a second calibration curve is depicted in accordance with an illustrative embodiment. Calibration curve 600 is another example of calibration curve 230, generated by calibration service 206 and displayed on graphical user interface 214 as shown in FIG. 2.

In this illustrative example, calibration curve 600 maps model confidence, such as model confidence 234 of FIG. 2, to a probability estimate of correctness, such as probabilities 236 of FIG. 2. As depicted, calibration curve 600 is a logistic curve, including best fit 610, bounded over the uncertainty interval 620.

In this illustrative example, calibration curve 600 can be generated using a same generic machine learning classification model as calibration curve 500 of FIG. 5. The generic machine learning classification model can be retrained from a different data, generating different weights and different properties for the logistic calibration function based on the data points, resulting in calibration curve 600 that is dramatically different from calibration curve 500 of FIG. 5.

The illustrations of a calibrations in FIGS. 5-6 are provided as one illustrative example of an implementation for calibrating a machine learning classification model with uncertainty interval and are not meant to limit the manner in which calibrating with uncertainty interval can be generated and presented in other illustrative examples.

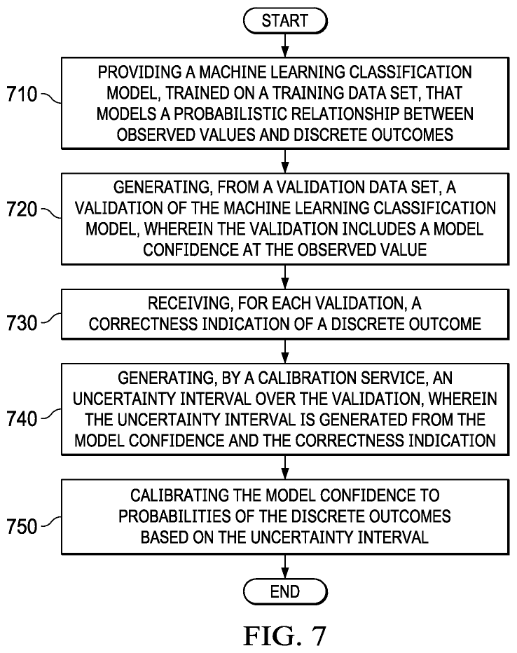

Turning next to FIG. 7, a flowchart of a process for calibrating a machine learning classification model with uncertainty interval is depicted in accordance with an illustrative embodiment. The process in FIG. 7 can be implemented in hardware, software, or both. When implemented in software, the process can take the form of program code that is run by one or more processor units located in one or more hardware devices in one or more computer systems. For example, the process can be implemented in calibration service 206 in computer system 204 in FIG. 2.

The process begins by providing a machine learning classification model that models a probabilistic relationship between observed values and discrete outcomes (step 710). The classification model is trained on data points in a training data set.

The process generates a validation of the machine learning classification model (step 720). The validations are generated from observed values for data points in a validation data set and includes a model confidence for model predictions at the observed value. For each validation, the process receives a correctness indication of a discrete outcome (step 730). The correctness indication can be received as part of a supervised learning process.

The process generates an uncertainty interval over the validation, wherein the uncertainty interval is generated from the model confidence and the correctness indication (step 740). The process calibrates the model confidence to probabilities of the discrete outcomes based on the uncertainty interval (step 750). Thereafter, the process terminates.

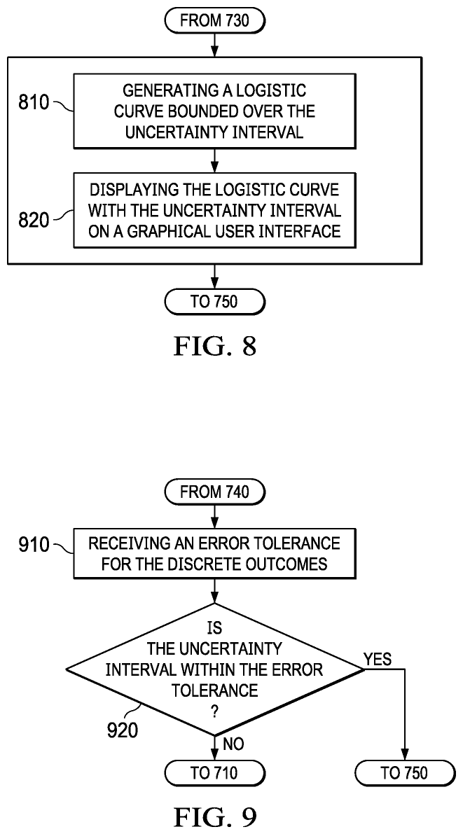

With reference next to FIG. 8, a flowchart of a process generating the uncertainty interval is depicted in accordance with an illustrative embodiment. The process in FIG. 8 is an example one implementation for step 740 in FIG. 7.

Continuing from step 730 of FIG. 7, the process generating a logistic curve bounded over the uncertainty interval (step 810). The process displays the logistic curve with the uncertainty interval on a graphical user interface (step 820). Thereafter, the process can continue to step 750 of FIG. 7.

With reference next to FIG. 9, a flowchart of a process for shrinking an uncertainty interval around a calibration is depicted in accordance with an illustrative embodiment. The process in FIG. 9 is an example of additional processing steps that can be performed as part of a process for calibrating a machine learning classification model with uncertainty interval, as shown in FIG. 7.

Continuing from step 740, the process receives an error tolerance for the discrete outcomes (step 910). The process determines determining if the uncertainty interval is within the error tolerance (step 920).

In responsive to determining that the uncertainty interval is within the error tolerance (“yes” at step 920), the process can continue to step 750 of FIG. 7, calibrating the model confidence to probabilities of the discrete outcomes based on the uncertainty interval. However, if the process determines that the uncertainty interval is not within the error tolerance (“no” at step 920), the process returns to step 710 of FIG. 7. Therefore, in this illustrative example, the process can iteratively generate additional validation and regenerate the uncertainty interval until the uncertainty interval shrinks to a desired error tolerance.

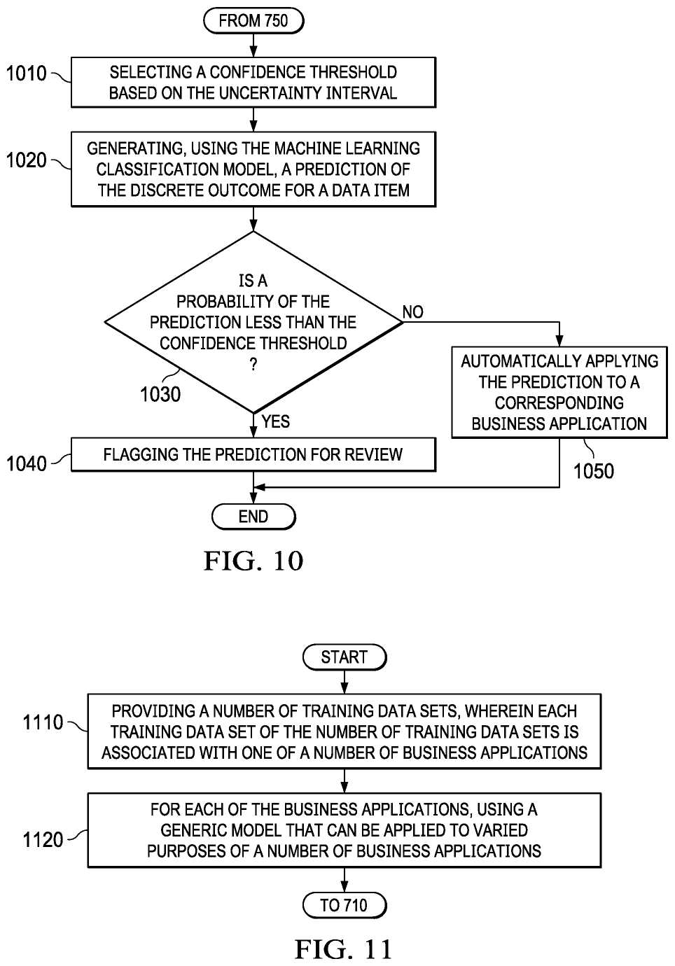

With reference next to FIG. 10, a flowchart of a process for applying model predictions according to a selected confidence threshold is depicted in accordance with an illustrative embodiment. The process in FIG. 10 is an example of additional processing steps that can be performed as part of a process for calibrating a machine learning classification model with uncertainty interval, as shown in FIG. 7.

Continuing from step 750 of FIG. 7, the process selects a confidence threshold based on the uncertainty interval (step 1010). Using the machine learning classification model, the process generates a prediction of the discrete outcome for a data item (step 1020). The process determines if a probability of the prediction is less than the confidence threshold (step 1030).

Responsive to determining that the probability of the prediction is not less than the confidence threshold, automatically applying the prediction to a corresponding business application (“no” at step 1030). However, if the process determines that the probability of the prediction is less than the confidence threshold (“yes” at step 1030), the process flags the prediction for review. Thereafter, the process terminates.

With reference next to FIG. 11, a flowchart of a process for calibrating a generic model is depicted in accordance with an illustrative embodiment. The process in FIG. 10 is an example of additional processing steps that can be performed as part of a process for calibrating a machine learning classification model with uncertainty interval, as shown in FIG. 7.

The process begins by a number of training data sets. Each training data set of the number of training data sets is associated with one of a number of business applications (step 1110).

For each of the business applications, the process uses a generic model that can be applied to varied purposes of a number of business applications (step 1120). Thereafter, the process continues to step 710 of FIG. 7. Therefore, in this illustrative example, a generic model can be calibrated and applied to a number of different business applications, including generating the validation, receiving the correctness indication, generating the uncertainty interval, and calibrating the model confidence.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks can be implemented as program code, hardware, or a combination of the program code and hardware. When implemented in hardware, the hardware may, for example, take the form of integrated circuits that are manufactured or configured to perform one or more operations in the flowcharts or block diagrams. When implemented as a combination of program code and hardware, the implementation may take the form of firmware. Each block in the flowcharts or the block diagrams can be implemented using special purpose hardware systems that perform the different operations or combinations of special purpose hardware and program code run by the special purpose hardware.

In some alternative implementations of an illustrative embodiment, the function or functions noted in the blocks may occur out of the order noted in the figures. For example, in some cases, two blocks shown in succession can be performed substantially concurrently, or the blocks may sometimes be performed in the reverse order, depending upon the functionality involved. Also, other blocks can be added in addition to the illustrated blocks in a flowchart or block diagram.

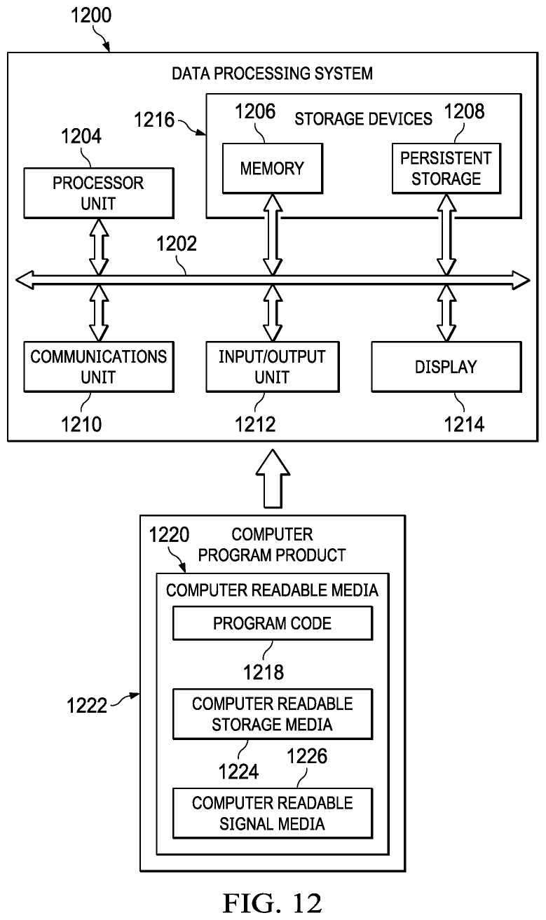

Turning now to FIG. 12, a block diagram of a data processing system is depicted in accordance with an illustrative embodiment. Data processing system 1200 can be used to implement server computer 104, server computer 106, client devices 110, in FIG. 1. Data processing system 1200 can also be used to implement computer system 204 in FIG. 2. In this illustrative example, data processing system 1200 includes communications framework 1202, which provides communications between processor unit 1204, memory 1206, persistent storage 1208, communications unit 1210, input/output (I/O) unit 1212, and display 1214. In this example, communications framework 1202 takes the form of a bus system.

Processor unit 1204 serves to execute instructions for software that can be loaded into memory 1206. Processor unit 1204 includes one or more processors. For example, processor unit 1204 can be selected from at least one of a multicore processor, a central processing unit (CPU), a graphics processing unit (GPU), a physics processing unit (PPU), a digital signal processor (DSP), a network processor, or some other suitable type of processor. Further, processor unit 1204 can may be implemented using one or more heterogeneous processor systems in which a main processor is present with secondary processors on a single chip. As another illustrative example, processor unit 1204 can be a symmetric multi-processor system containing multiple processors of the same type on a single chip.

Memory 1206 and persistent storage 1208 are examples of storage devices 1216. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 1216 may also be referred to as computer-readable storage devices in these illustrative examples. Memory 1206, in these examples, can be, for example, a random-access memory or any other suitable volatile or non-volatile storage device. Persistent storage 1208 may take various forms, depending on the particular implementation.

For example, persistent storage 1208 may contain one or more components or devices. For example, persistent storage 1208 can be a hard drive, a solid-state drive (SSD), a flash memory, a rewritable optical disk, a rewritable magnetic tape, or some combination of the above. The media used by persistent storage 1208 also can be removable. For example, a removable hard drive can be used for persistent storage 1208.

Communications unit 1210, in these illustrative examples, provides for communications with other data processing systems or devices. In these illustrative examples, communications unit 1210 is a network interface card.

Input/output unit 1212 allows for input and output of data with other devices that can be connected to data processing system 1200. For example, input/output unit 1212 may provide a connection for user input through at least one of a keyboard, a mouse, or some other suitable input device. Further, input/output unit 1212 may send output to a printer. Display 1214 provides a mechanism to display information to a user.

Instructions for at least one of the operating system, applications, or programs can be located in storage devices 1216, which are in communication with processor unit 1204 through communications framework 1202. The processes of the different embodiments can be performed by processor unit 1204 using computer-implemented instructions, which may be located in a memory, such as memory 1206.

These instructions are program instructions and are also referred are referred to as program code, computer usable program code, or computer-readable program code that can be read and executed by a processor in processor unit 1204. The program code in the different embodiments can be embodied on different physical or computer-readable storage media, such as memory 1206 or persistent storage 1208.

Program code 1218 is located in a functional form on computer-readable media 1220 that is selectively removable and can be loaded onto or transferred to data processing system 1200 for execution by processor unit 1204. Program code 1218 and computer-readable media 1220 form computer program product 1222 in these illustrative examples. In the illustrative example, computer-readable media 1220 is computer-readable storage media 1224.

In these illustrative examples, computer-readable storage media 1224 is a physical or tangible storage device used to store program code 1218 rather than a medium that propagates or transmits program code 1218. Computer-readable storage media 1224, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. The term “non-transitory” or “tangible”, as used herein, is a limitation of the medium itself (i.e., tangible, not a signal) as opposed to a limitation on data storage persistency (e.g., RAM vs. ROM).

Alternatively, program code 1218 can be transferred to data processing system 1200 using a computer-readable signal media. The computer-readable signal media are signals and can be, for example, a propagated data signal containing program code 1218. For example, the computer-readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer-readable media” can be singular or plural. For example, program code 1218 can be located in computer-readable media 1220 in the form of a single storage device or system. In another example, program code 1218 can be located in computer-readable media 1220 that is distributed in multiple data processing systems. In other words, some instructions in program code 1218 can be located in one data processing system while other instructions in program code 1218 can be located in one data processing system. For example, a portion of program code 1218 can be located in computer-readable media 1220 in a server computer while another portion of program code 1218 can be located in computer-readable media 1220 located in a set of client computers.

The different components illustrated for data processing system 1200 are not meant to provide architectural limitations to the manner in which different embodiments can be implemented. In some illustrative examples, one or more of the components may be incorporated in or otherwise form a portion of, another component. For example, memory 1206, or portions thereof, may be incorporated in processor unit 1204 in some illustrative examples. The different illustrative embodiments can be implemented in a data processing system including components in addition to or in place of those illustrated for data processing system 1200. Other components shown in FIG. 12 can be varied from the illustrative examples shown. The different embodiments can be implemented using any hardware device or system capable of running program code 1218.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

The descriptions of the various embodiments of the present invention have been presented for purposes of illustration but are not intended to be exhaustive or limited to the embodiments disclosed. Not all embodiments will include all of the features described in the illustrative examples. Further, different illustrative embodiments may provide different features as compared to other illustrative embodiments. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

What is claimed is:

1. A method for calibrating a machine learning classification model with uncertainty interval, the method comprising:
providing a machine learning classification model, trained on a training data set, that models a probabilistic relationship between observed values and discrete outcomes;
generating, from a validation data set, a validation of the machine learning classification model, wherein the validation includes a model confidence at the observed value;
receiving, for each validation, a correctness indication of a discrete outcome;
generating, by a calibration service, an uncertainty interval over the validation, wherein the uncertainty interval is generated from the model confidence and the correctness indication; and
calibrating the model confidence to probabilities of the discrete outcomes based on the uncertainty interval.

2. The method of claim 1, wherein generating the uncertainty interval further comprises:
generating a logistic curve bounded over the uncertainty interval; and
displaying the logistic curve with the uncertainty interval on a graphical user interface.

3. The method of claim 1, further comprising:
receiving an error tolerance for the discrete outcomes;
determining if the uncertainty interval is within the error tolerance; and
responsive to determining that the uncertainty interval is not within the error tolerance, iteratively performing, for a set of additional validations, the steps of generating the validation, receiving the correctness indication, and generating the uncertainty interval.

4. The method of claim 1, further comprising:
selecting a confidence threshold based on the uncertainty interval;
generating, using the machine learning classification model, a prediction of the discrete outcome for a data item; and
determining if a probability of the prediction is less than the confidence threshold.

5. The method of claim 4, further comprising:
responsive to determining that the probability of the prediction is less than the confidence threshold, flagging the prediction for review.

6. The method of claim 4, further comprising:
responsive to determining that the probability of the prediction is not less than the confidence threshold, automatically applying the prediction to a corresponding business application.

7. The method of claim 1, wherein the machine learning classification model is a generic model that can be applied to varied purposes of a number of business applications, the method further comprising:
providing a number of training data sets, wherein each training data set of the number of training data sets is associated with one of a number of business applications;
for each of the business applications, using the generic model, independently performing the steps of generating the validation, receiving the correctness indication, generating the uncertainty interval, and calibrating the model confidence ; and
wherein the model confidence associated with each business application is calibrated on the training data set that is specific to a corresponding business application.

8. A computer system comprising:
a hardware processor;
a machine learning classification model, in communication with the hardware processor, trained on a training data set, that models a probabilistic relationship between observed values and discrete outcomes;
a calibration service, in communication with the hardware processor in machine learning classification model, wherein the calibration service is configured:
to generate, from a validation data set, a validation of the machine learning classification model, wherein the validation includes a model confidence at the observed value;
to receive, for each validation, a correctness indication of a discrete outcome;
to generate an uncertainty interval over the validation, wherein the uncertainty interval is generated from the model confidence and the correctness indication; and
to calibrate the model confidence to probabilities of the discrete outcomes based on the uncertainty interval.

9. The computer system of claim 8, wherein in generating the uncertainty interval, the calibration service is further configured:
to generate a logistic curve bounded over the uncertainty interval; and
to display the logistic curve with the uncertainty interval on a graphical user interface.

10. The computer system of claim 8, wherein the calibration service is further configured:
to receive an error tolerance for the discrete outcomes;
to determine if the uncertainty interval is within the error tolerance; and
responsive to determining that the uncertainty interval is not within the error tolerance, to iteratively perform, for a set of additional validations, the steps of generating the validation, receiving the correctness indication, and generating the uncertainty interval.

11. The computer system of claim 8, wherein the calibration service is further configured:
to select a confidence threshold based on the uncertainty interval;
to generate, using the machine learning classification model, a prediction of the discrete outcome for a data item; and
to determine if a probability of the prediction is less than the confidence threshold.

12. The computer system of claim 11, wherein the calibration service is further configured:
responsive to determining that the probability of the prediction is less than the confidence threshold, flagging the prediction for review.

13. The computer system of claim 11, wherein the calibration service is further configured:
responsive to determining that the probability of the prediction is not less than the confidence threshold, automatically applying the prediction to a corresponding business application.

14. The computer system of claim 8, wherein the machine learning classification model is a generic model that can be applied to varied purposes of a number of business applications, further comprising:
a number of training data sets, wherein each training data set of the number of training data sets is associated with one of a number of business applications; wherein the calibration service is further configured:
for each of the business applications, using the generic model, independently performing the steps of generating the validation, receiving the correctness indication, generating the uncertainty interval, and calibrating the model confidence; and
wherein the model confidence associated with each business application is calibrated on the training data set that is specific to a corresponding business application.

15. A computer program product comprising:
a computer readable storage media; and
program code, stored on the computer readable storage media, for calibrating a machine learning classification model with uncertainty interval, the program code comprising:
program code for providing a machine learning classification model, trained on a training data set, that models a probabilistic relationship between observed values and discrete outcomes;
program code for generating, from a validation data set, a validation of the machine learning classification model, wherein the validation includes a model confidence at the observed value;
program code for receiving, for each validation, a correctness indication of a discrete outcome;
program code for generating an uncertainty interval over the validation, wherein the uncertainty interval is generated from the model confidence and the correctness indication; and
program code for calibrating the model confidence to probabilities of the discrete outcomes based on the uncertainty interval.

16. The computer program product of claim 15, wherein the program code for generating the uncertainty interval further comprises:
program code for generating a logistic curve bounded over the uncertainty interval; and
program code for displaying the logistic curve with the uncertainty interval on a graphical user interface.

17. The computer program product of claim 15, further comprising:
program code for receiving an error tolerance for the discrete outcomes;
program code for determining if the uncertainty interval is within the error tolerance; and
program code for iteratively performing, for a set of additional validations in response to determining that the uncertainty interval is not within the error tolerance, the steps of generating the validation, receiving the correctness indication, and generating the uncertainty interval.

18. The computer program product of claim 15, further comprising:
program code for selecting a confidence threshold based on the uncertainty interval;
program code for generating, using the machine learning classification model, a prediction of the discrete outcome for a data item; and
program code for determining if a probability of the prediction is less than the confidence threshold.

19. The computer program product of claim 18, further comprising:
program code for flagging the prediction for review in response to determining that the probability of the prediction is less than the confidence threshold.

20. The computer program product of claim 18, further comprising:
program code for automatically applying the prediction to a corresponding business application in response to determining that the probability of the prediction is not less than the confidence threshold.

21. The computer program product of claim 15, wherein the machine learning classification model is a generic model that can be applied to varied purposes of a number of business applications, the computer program product further comprising:
program code for providing a number of training data sets, wherein each training data set of the number of training data sets is associated with one of a number of business applications; and
program code for using the generic model to independently perform, for each of the business applications, the steps of generating the validation, receiving the correctness indication, generating the uncertainty interval, and calibrating the model confidence;
wherein the model confidence associated with each business application is calibrated on the training data set that is specific to a corresponding business application.
